(19) United States
(12) Patent Application Publication
(10) Pub. No.: US 2008/0289478 A1
(43) Pub. Date: Nov. 27, 2008

(54) PORTABLE MUSIC RECORDING DEVICE

(76) Inventor: John Vella, South Coogee (AU)

Correspondence Address: SNELL & WILMER LLP (OC), 600 ANTON BOULEVARD, SUITE 1400, COSTA MESA, CA, 92626, US

(21) Appl. No.: 11/952,716

(22) Filed: Dec. 7, 2007

(30) Foreign Application Priority Data
May 23, 2007 (AU) 2007202341

(51) Int. Cl. G10H 7/00

(52) U.S. Cl. 84/602; 84/645

(57) ABSTRACT

The invention concerns a portable music recording device, comprising a virtual keyboard for recording music tracks in a standard file format. A microphone for recording audio tracks. A processor for converting recorded audio tracks to the standard format file. And an electronic memory for storage of standard format files. The device may also comprise a built-in speaker for playback of standard format files as audio tracks. In another aspect, the invention concerns a computer program for recording and processing audio tracks on a portable music recording device.

### TECHNICAL FIELD

This invention concerns a portable music recording device. In another aspect, the invention concerns a computer program for recording and processing audio tracks on a portable music recording device.

### BACKGROUND ART

Songwriters use portable music recording devices, such as small cassette tape recorders to record, for instance, new melodies that come to mind. The portable nature of the recording device is important because it is impossible to predict when inspiration will strike.

### SUMMARY OF THE INVENTION

The invention is a portable music recording device, comprising

a virtual keyboard for recording music tracks in a standard file format,

a microphone for recording audio tracks,

a processor for converting recorded audio tracks to the standard format file, and

an electronic memory for storage of standard format files.

A built-in speaker may be provided for playback of standard format files as audio tracks.

The virtual keyboard may be a laser keyboard projected by the device or a touchscreen keyboard displayed on the device.

By providing the virtual keyboard the user is able to record musical ideas, such as a melody, as if they had access to a piano. Alternatively they may use another instrument or voice and record them using the microphone. This flexibility allows the user to use whatever is most convenient at the time inspiration arrives.

When notes and chords are played at the virtual keyboard the device may automatically and simultaneously play them back to the user.

The same notes and chords may be stored for playback later using a selected instrument.

Additional tracks may be added to the same file.

The standard file format may be MIDI. Tracks recorded using the virtual keyboard may be recorded directly in MIDI format.

Voice and other recorded instruments generate audio files that may subsequently be converted into MIDI format.

Editing functions may be incorporated into the device to adjust recorded tracks and files. Editing is conveniently applied to MIDI files.

The device may also include instrument synthesis software able to replay music recorded by voice, instrument or the virtual keyboard, on any selected synthesized instrument.

The processor may be able to synchronize different audio and music tracks together, for instance using time stretching techniques.

The device may be able to playback several tracks simultaneously to create a multi-channel playback experience.

The device may incorporate an MP3 player to record and playback music.

In another aspect, the invention is a computer program for recording and processing audio tracks on a portable music recording device comprising a microphone, processor and an electronic memory for storage of standard file formats; the computer program operable to:

provide a virtual keyboard for recording music tracks in a standard file format;

and receive raw audio tracks recorded using a microphone associated with the device and convert the received raw audio tracks to a standard file format

The standard file format may be MIDI. Tracks recorded using the virtual keyboard may be recorded directly in MIDI format.

The virtual keyboard may be a laser keyboard projected by the device or a touchscreen keyboard displayed on the device.

The computer program may be further operable to detect and adjust pitch of the received raw audio tracks before converting the adjusted audio tracks to the standard file format.

The computer program may be further operable to add additional tracks to a music or audio track recorded in standard file format.

The computer program may be further operable to cause a speaker associated with the device to automatically and simultaneously play notes and cords recorded by the virtual keyboard back to the user.

The computer program may be further operable to replay music recorded by voice, instrument or the virtual keyboard, on any selected synthesized instrument.

The computer program may be further operable to synchronize different audio and music tracks together, for instance using time stretching techniques.

The computer program may be further operable to playback several tracks simultaneously to create a multichannel playback experience.

### BRIEF DESCRIPTION OF THE DRAWINGS

An example of the invention will now be described with reference to the accompanying drawings, in which:

FIG. 1 is a pictorial view of the portable music recording device.

FIG. 2 is block diagram of the functionality of the device of FIG. 1.

FIG. 3 is a menu map for the device of FIG. 1.

FIG. 4 is a schematic of another embodiment of the portable music recording device.

### DETAILED DESCRIPTION OF THE INVENTION

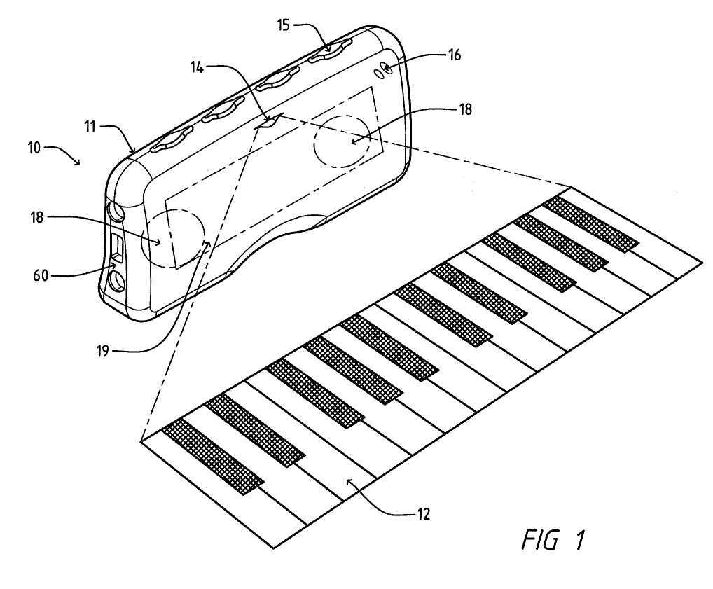

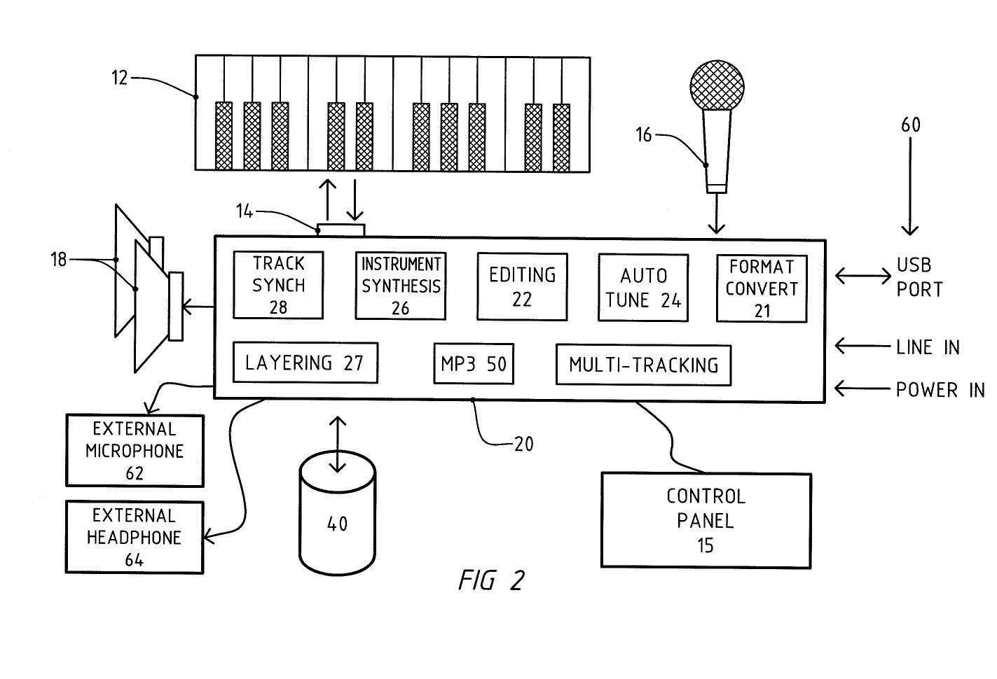

Referring first to FIGS. 1 and 2, the portable music recording device 10 is encased in a hard plastics shell 11 from which the virtual keyboard 12 is selectively projected via a transceiver orifice 14. A control panel 15 on the top of the device contains an array of buttons to control device operation. The device 10 also includes a built-in condenser microphone 16 and stereo speakers 18. A panel 19 in the shell is semi-transparent and allows the display of status and other information using, for instance using organic EL technology mounted within the shell.

Within the device 10 is a processor 20 that controls all the operations of the device, including:

Format converting software 21 to translate recorded audio into MIDI format.

Editing software 22 to adjust recorded MIDI files.

Auto tune software 24 to adjust raw recorded voice and instrument tracks.

Instrument synthesis software 26 to replay music recorded by voice, instrument or the virtual keyboard, on any selected synthesized instrument.

Layering software 27.

Track synchronizing software 28 to synchronize different musical tracks together, for instance using time stretching techniques.

Multi-track playback software 30 to playback 8 layers of digital recording simultaneously.

The device also includes a computer memory 40, ideally with a capacity greater than 10 GB to store a variety of different files, including:

Recorded audio tracks.

Recorded MIDI tracks of at least two minutes duration.

A library of rhythm tracks, all tempos and different styles.

In addition base effects, including bass and drum samples, reference tones, loud distinct tones, all mid range notes across at least two octaves.

Other samples such as orchestral and synth samples.

The device also includes click track functionality ranging from 20 to 250 heats per minute.

The inclusion of an MP3 player 50 also provides a conventional recreational use for the device.

The device also includes a range of connection ports 60 including a line in for all instruments, external microphone 62 and stereo headphones 64, as well as a mini USB port for up/downloading and charging.

The device is portable, designed to stand steadily, to be operatable with one hand, to fit the pocket, to be durable and to look great.

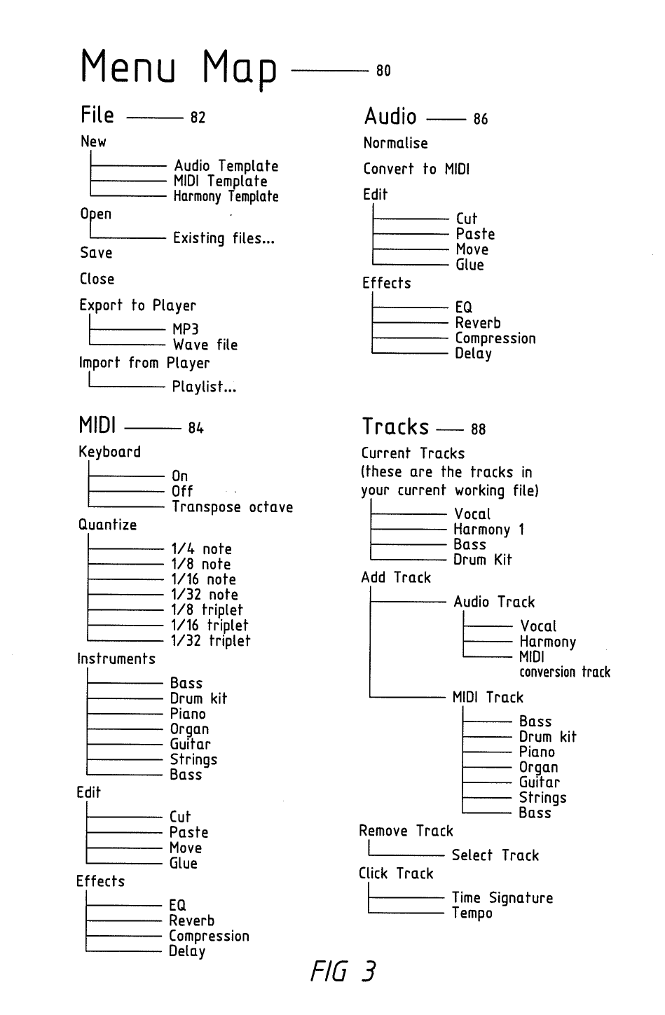

FIG. 3 is a map of the functionality provided by the device. The user accesses this menu 80 via the control panel 15.

The File menu 82 allows the creation of new files, the importing of files from the MP3 player, or working on existing files. These files can then be saved and exported to the MP3 player or to a wave file format.

The MIDI menu 84 allows the virtual keyboard to be turned on and off, transposing the keyboard to different octaves. In addition it allows quantisation of notes and selection of instruments. This menu also facilitates editing of MIDI files and introduction of effects, such as equalisation, reverb, compression and delay.

The Audio menu 86 allows normalisation, conversion of audio files to MIDI format as well as editing and effects for the audio files.

The Tracks menu 88 displays the tracks currently defined for the current working file; in this case: Vocal, Harmony, Bass and Drum kit. It also allows new tracks to be added, either audio or MIDI format. Tracks can also be deleted. This menu also allows the use of Click Track.

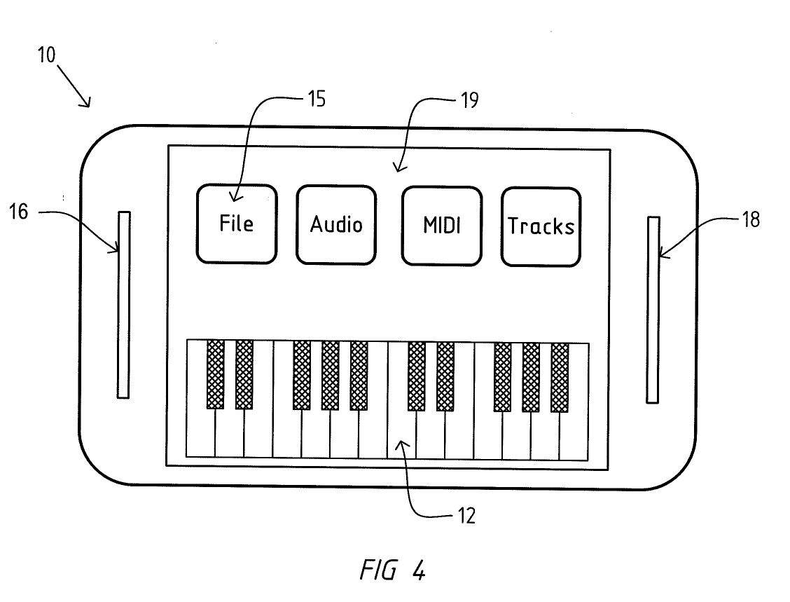

In another embodiment shown in FIG. 4, the device is a commercial portable media player 10′ comprising a built-in microphone 16′, stereo speakers 18′, electronic memory (not shown), a display screen 19′ providing a control panel 15′ and a virtual keyboard 12′. Similarly, the portable media player 10′ may be installed with software providing various functions of format converting 21, editing 22, auto-tuning 24, instrument synthesising 26, layering 27, track synchronizing 28 and multi-track playback 28.

As an example of use, the user will turn the device on and record a new vocal track by singing a bass line. The user may then play this track back with a bass guitar playing the sung notes. Of course the same could be done for a melody or harmony. The device can also play the track back using any other supported instrument; for instance strings or horn. New tracks can be added with different instruments to generate a full band for play back on multiple channels.

Although the invention has been described with reference to a particular example, it should be appreciated that it could be exemplified in many other forms and in combination with other features not mentioned above.

What is claimed is:

1. A portable music recording device, comprising:
a virtual keyboard for recording music tracks in a standard file format,
a microphone for recording audio tracks,
a processor for converting recorded audio tracks to the standard format file, and
an electronic memory for storage of standard format files.

2. The device according to claim 1 further comprising a built-in speaker for playback of standard format files as audio tracks.

3. The device according to claim 2 wherein, when notes and chords are played at the virtual keyboard, the device automatically and simultaneously plays them back to the user.

4. The device according to claim 3, wherein the same notes and chords are stored for playback later using a selected instrument.

5. The device according to claim 1, wherein additional tracks are added to the same file.

6. The device according to claim 1, wherein the standard file format is MIDI.

7. The device according to claim 1, wherein tracks recorded using the virtual keyboard are recorded directly in MIDI format.

8. The device according to claim 1, wherein recorded audio tracks automatically generate audio files that are subsequently converted into MIDI format.

9. The device according to claim 1, wherein editing functions are incorporated into the device to adjust recorded tracks and files.

10. The device according to claim 9, wherein editing is applied to MIDI files.

11. The device according to claim 1, further comprising instrument synthesis software to replay music recorded by voice, instrument or the virtual keyboard, on any selected synthesized instrument.

12. The device according to claim 1, wherein the processor is able to synchronize different musical tracks together.

13. The device according to claim 1, wherein the device is able to playback several tracks simultaneously.

14. The device according to claim 1, wherein the device incorporates an MP3 player.

15. A computer program for recording and processing audio tracks on a portable music recording device comprising a microphone, processor and an electronic memory for storage of standard file formats; the computer program operable to:
provide a virtual keyboard for recording music tracks in a standard file format;
and receive raw audio tracks recorded using a microphone associated with the device and convert the received raw audio tracks to a standard file format

16. The computer program according to claim 15, further operable to detect and adjust pitch of the received raw audio tracks before converting the adjusted audio tracks to the standard file format.

17. The computer program according to claim 15, further operable to add additional tracks to a music or audio track recorded in standard file format,

18. The computer program according to claim 15, further operable to cause a speaker associated with the device to automatically and simultaneously play notes and cords recorded by the virtual keyboard back to the user.

19. The computer program according to claim 15, further operable to replay one or more tracks recorded by voice, instrument or the virtual keyboard, on any selected synthesized instrument.

20. The computer program according to claim 15, further operable to playback several tracks simultaneously.

21. The computer program according to claim 15, further operable to synchronize different audio and music tracks together, for instance using time stretching techniques.

22. The computer program according to claim 15, wherein the standard file format is MIDI.

23. The computer program according to claim 15, wherein the virtual keyboard is a laser keyboard projected by the device or a touchscreen keyboard displayed on the device.
